(19) United States
(12) Patent Application Publication
(10) Pub. No.: US 2007/0175250 A1
(43) Pub. Date: Aug. 2, 2007

(54) Locking gate latches

(75) Inventors: Irek Karcz, Cromer (AU); Anthony John Clark, Cremorne (AU); Dezso Kiraly, Meadowbank (AU)

Correspondence Address: FULWIDER PATTON LEE & UTECHT, LLP, 200 OCEANGATE, SUITE 1550, LONG BEACH, CA, 90802, US

(73) Assignee: D & D Group Pty Ltd

(21) Appl. No.: 11/700,588

(22) Filed: Jan. 31, 2007

(30) Foreign Application Priority Data
Jan. 31, 2006 (AU) 2006900451

(51) Int. Cl. E05B 65/06

(52) U.S. Cl. 70/101

(57) ABSTRACT

A gate latch is adapted to be installed on a gate post and a complementary striker arm is secured typically to a gate so that, upon closure of the gate, the striker arm engages a displaceable latching element mounted in a housing of the latch to displace the latching element. The latching element is biased towards its open position but when the striker arm engages with the latching element it is displaced, thereby releasing an interference portion of a biased locking element, whereby the locking element is released to move under its biasing into a locking position so that self-locking is provided for the latch. A rotary release mechanism may be actuated to return the locking element so that they latching element can be released to release the striker bar and the gate may be opened.

### FIELD OF THE INVENTION

The present invention relates to latches for gates and doors and more particularly is concerned with a latch of the type wherein a displaceable element (usually called a tongue) has a latching shoulder to engage with a striker arm with respect to which it is relatively moveable, the tongue having a striker surface adapted to engage with the striker arm to displace the tongue to permit engagement of the striker arm behind the latching shoulder. Typically, the biasing of the tongue will be under gravity, for example through a pivotal mounting and there is an arrangement to permit the tongue to be displaced to release the striker arm whereby a gate or door is then released to be moved relative to a gate post or door post.

The field of the invention extends to devices having spring biased tongues as well as gravity biased tongues and, in addition, extends to tongues which are both gravity and spring biased.

### BACKGROUND OF THE INVENTION

Various forms of latches and, in particular, gravity latches, have been previously proposed such as U.S. Pat. No. 6,058,747 (Doyle) and U.S. Pat. No. 6,513,351 (Clark), both of which are assigned to the assignees of the present invention. These two US patents disclose specific developments in the field of latches for gates and doors. Other known prior latches in the field of those referred to as references in the printed specifications of the two US patents mentioned above. The prior art listed comprises:

| | |
|---|---|
| 204,267 | Unger |
| 2,313,712 | Jacobi |
| 2,953,916 | Thomas |
| 3,115,026 | Moore |
| 3,433,518 | Foltz |
| 3,593,547 | Taylor |
| 3,677,591 | Waldo |
| 3,785,186 | James et al |
| 3,838,877 | Hanson |
| 4,014,192 | Dillon et al |
| 4,378,684 | Dugan et al |
| 4,691,541 | McQuade et al |
| 4,732,418 | Crown et al |
| 4,919,463 | McQuade, Sr. |
| 4,938,508 | Thomas |
| 5,024,473 | McQuade |
| 5,063,764 | Amis et al |
| 5,103,658 | McQuade |
| 5,358,292 | Van Wiebe et al |
| 6,058,747 | Doyle et al |
| 6,347,819 | Plaxco |

U.S. Pat. No. 6,058,747 (Doyle et al) has a disclosure of a gravity latch having an enshrouded tongue and the lock mounted to be accessible from the front face. The disclosure includes a rear actuator unit adapted to be mounted on the opposite or rear face of a gate post so that, subject to any unlocking required of the rear unit, the tongue can be raised by the rear actuator to release the striker arm so that the gate may be opened from the rear side.

U.S. Pat. No. 6,513,351 (Clark) is a development with cylinder locks provided in front and rear units and respectively key operated to rotate a locking element into and out of a locking position. In the locking position the gravity biased tongue is locked in a retaining position in which the associated striker arm is held in position.

The prior published specifications referred to above are mentioned as an illustration of the background but in doing so, no admission is made that any of the specifications form part of the common general knowledge in Australia or any other geographical region.

In this specification, unless the context requires otherwise, the word “comprising” is used in the non exhaustive sense and further features may be present in the arrangement described.

The present invention is directed to new and useful alternatives to known arrangements.

### SUMMARY OF THE INVENTION

According to the present invention in one aspect, broadly there is provided a latch for holding closed a gate (or door) wherein the latch is adapted to co operate with a striker arm, the latch comprising:

(a) a housing in which

(b) a displaceable latching element is mounted to be displaceable from a latching position towards an open position in which the striker arm is released for gate opening, and

(c) the latching element having a latching shoulder to retain the striker arm when engaged behind the latching shoulder and having an engagement surface adapted to be engaged by the striker arm when the gate is moved towards a closed position to displace the latching element and for permitting relative movement of the striker arm to adopt a position behind the latching shoulder,

(d) a locking element for locking the latching element and adapted to be displaced between a locking position, in which the latching element is restrained from moving, and a displaced position in which the latching element is free to be moved,

(e) the locking element being biased towards the locking position,

(f) the latching element being biased towards an open position,

(g) the latching element having an interference portion which operates when the latching element has been displaced away from the latching position to prevent the locking element returning to its locking position, and

(h) the arrangement being such that when a striker arm engages the latching element upon closure of an associated gate, the latching element is displaced thereby releasing the interference portion from the locking element whereby the locking element is released to move into the locking position so that a self locking arrangement is provided.

The housing may mount a lock having key actuation to displace the locking element in a rotary sense. The lock may be a cylinder lock with the locking element being in the form of a rotor, which may be rotatable through about 20° between its locking position and its displaced position.

The rotor may have first and second radially extending projections, the rearward of the projections having a side free for engaging the interference portion of the latching element, the side face being in a radial plane displaced around the axis of the rotor compared with a central radial plane around which the forward of the projections extends, an aperture being defined between the projections for accommodating a projecting tab of the latching element, whereby in the closed position of the latching element is retained by the projecting tab in the aperture.

The latch may be used with a remote actuator unit adapted to be mounted on the opposite side of the door or gate to the latch. The latch may incorporate the lock which can directly drive the locking element and the remote actuator may also have a key-operated lock so that either lock may unlock the latch.

Alternatively either the latch or remote actuator may have a key-operated lock and the other may have a manually actuated device for releasing the latch so that the door or gate can be opened. The manual actuator may be a button or emergency exit type crash bar.

The latching element can be biased suitably. One embodiment is upward biasing by a spring but magnetic, gravity or other biasing may be used. The locking element could be an arranged above or below the location at which in use the striker bar will present itself to the latching element.

Embodiments of the invention lend themselves to being used with a cylinder lock and the locking element being in the form of a rotor which is rotatable and mounted coaxially with the axis of the cylinder lock.

The latching element can be plate-like and can be substantially wholly enclosed for pivotal movement about a horizontal axis within the housing, a spring being provided for biasing the latching element towards the open position. However the latching element need not be pivotal or arranged as in this embodiment. For example the latching element may be of the nature of a sliding plate in a guide with a profiled exposed portion to function as a cam surface when engaged by the striker arm for displacement of the latching element during latching and self locking engagement.

Embodiments of the invention lend themselves to co operation with an optional rear actuator unit adapted to be mounted on the opposite side of a gate post to that of the latch. For this purpose the locking element is structured so that it can move relative to a base portion of the housing and the base portion of the housing is adapted to receive therethrough an actuating element associated with the rear actuator unit for operating the mechanism and in particular moving the locking element from the locking position and a displaced position. This may be achieved by providing a rotatable lock, such as a cylinder lock, in the rear unit and which drives a coupling bar which is in engagement with the locking element to rotate it from the locking position to the displaced position.

Where an egress mechanism is required in the rear operating unit, it may be in the form of a depressible actuator, for example in the form of a button or the like which moves in a guide towards the associated gate post, its motion being translated through a mechanical arrangement to provide rotary drive to move the latching element so that unlocking is achieved and the gate may be opened. For example a rack and pinion or worm and nut or similar mechanism may be used.

The embodiments illustrated are for normal operation of a key-operated lock. However, other embodiments may be configured by having remote electrical operation of either lock.

Other features and advantages of the invention will become apparent from the following detailed description, taken in conjunction with the accompanying drawings which illustrate, by way of example, the features of the invention

### BRIEF DESCRIPTION OF THE DRAWINGS

An embodiment of the invention will now be described with reference to the accompanying drawings, of which:

FIG. 1 is an exploded view of a front unit for a latch embodying the invention;

FIG. 2 is an exploded view of a complementary latching arm intended to be fitting to a gate;

FIG. 3 is an exploded view of a cartridge assembly for the lock unit of FIG. 1;

FIG. 4 is an exploded view of a rear access unit for use with the embodiment of FIG. 1;

FIG. 5 is a cross sectional view through the front unit showing the tongue in a latching position but prior to engagement with a striker bar;

FIG. 6 is a front elevation of the front unit of FIG. 5;

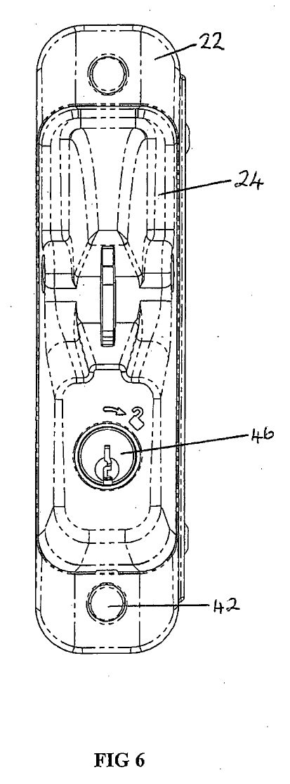

FIG. 7 is a view corresponding with FIG. 5 showing engagement by a striker bar;

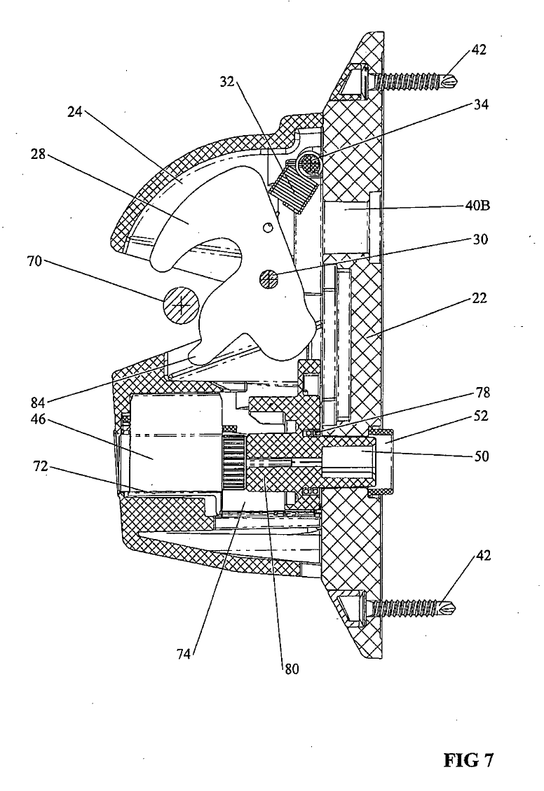

FIG. 8 is a part sectional view on an enlarged scale taken in a plane at right angles to the axis of the cylinder lock and rotor showing inter engagement between the tongue and the rotor prior to engagement of the striker bar, the rotor being held displaced from its final locking position; and

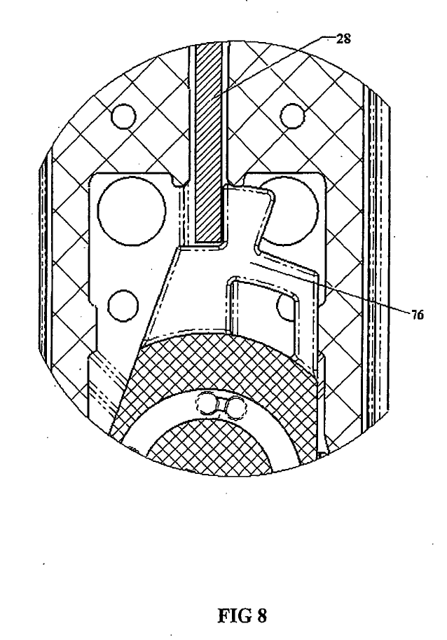

FIG. 9 corresponds with FIG. 7 but shows the components when in the locked position.

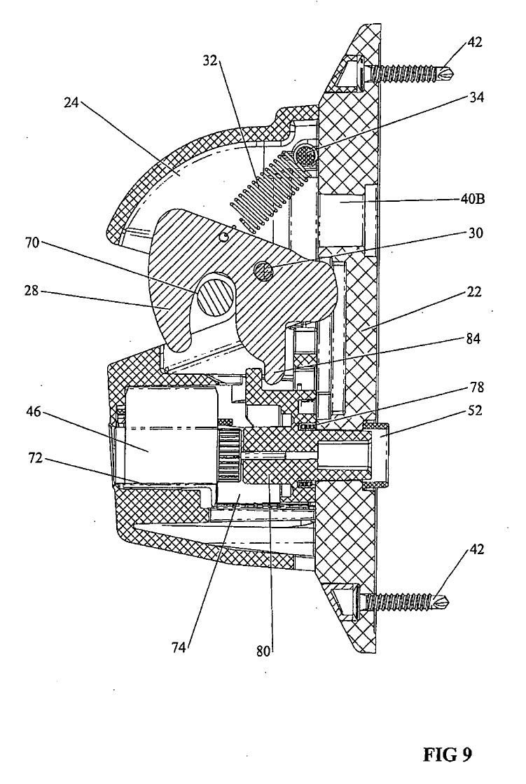

### DETAILED DESCRIPTION OF THE PREFERRED EMBODIMENTS

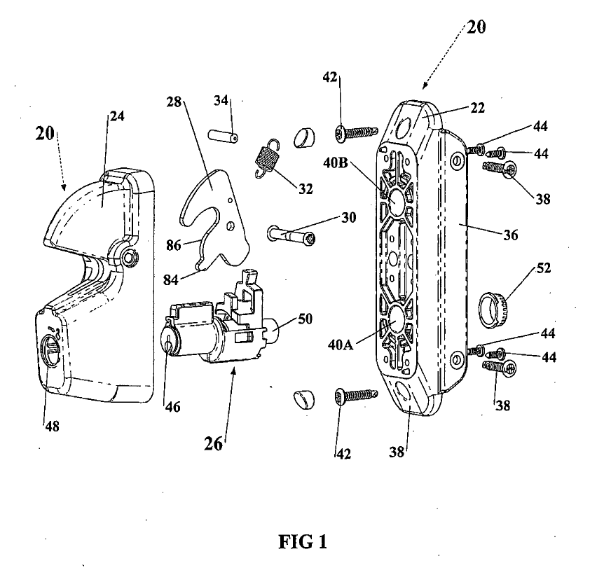

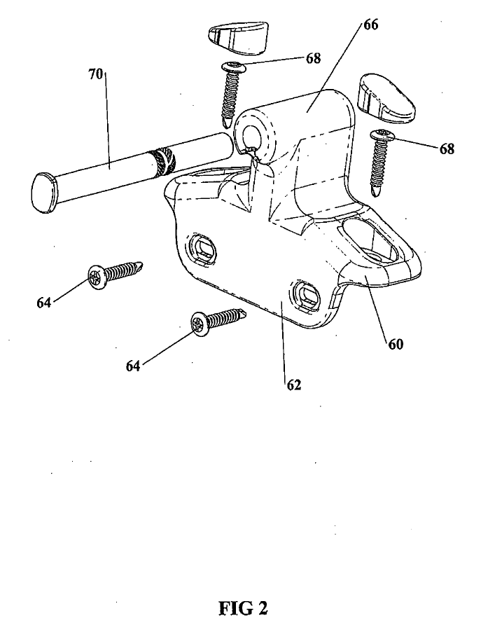

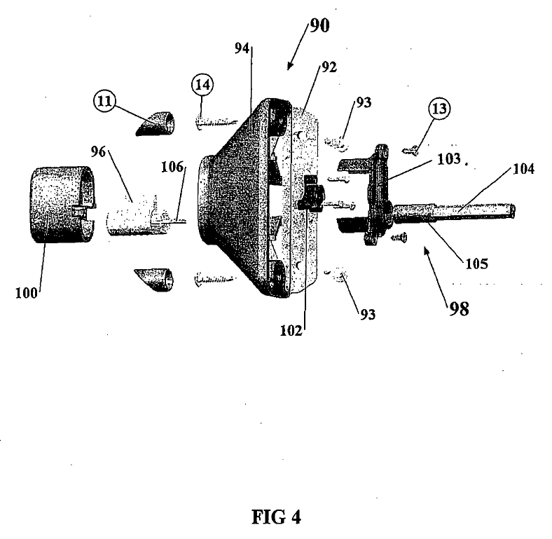

Referring first to the exploded view of FIG. 1, the front unit for a latch assembly is illustrated. It is adapted to cooperate in use with a striker arm assembly shown in FIG. 2 and optionally to be employed with a rear access unit shown in exploded view in FIG. 4. As shown in FIG. 1, the latch unit comprises a housing 20 assembled from a base unit 22 and a front shell 24 within which is mounted a locking cartridge assembly 26 for cooperation with a pivotal latching tongue 28. The tongue is mounted in the shell 24 on a pivot pin 30 and the tongue is adapted to be biased upwardly to its open position by a helical extension spring 32 which, at its upper end, is mounted on a mounting pin 34 and, at its lower end, is connected directly to the tongue.

The base 22 is generally L shaped in plan view and has a side leg 36 adapted to be engaged over the face of a gate post and secured to the gate post by screws 38. A main leg 39 of the base is symmetrical with two vertically spaced apertures 40A and 40B and this leg is also adapted to be secured to the gate post by upper and lower screws 42. The shell 24, when the components are assembled inside, is fitted to the base by a series of four screws 44 from the rear of the base into the shell 24 with the cylinder lock 46 of the cartridge engaged in a corresponding aperture 48 in the shell and a rear barrel portion 50 of the cartridge engaged in the lower aperture 40A.

So that the gate latch can be fitted to either left hand or right hand opening gates, the unit can be reassembled with the base 22 rotated through 180° so that the opening 40B is lower and adapted to be engaged by the barrel 50.

The striker pin unit of FIG. 2 is adapted to be fixed to an edge portion of a gate and for that purpose has an L shaped striker bracket 60 with a side leg 62 adapted to be secured to a side face of the gate by two fixing screws 64 and the other leg of the bracket has an integral upstanding body portion 66 also adapted to be secured to the gate but through a front face by two screws 68. The body portion mounts a steel striker pin 70.

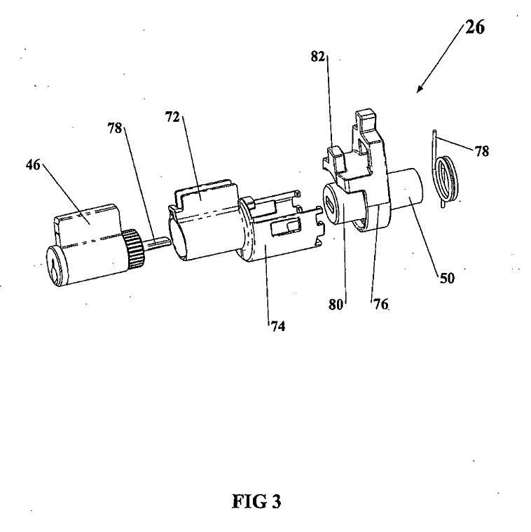

FIG. 3 shows details of the cartridge 26 which comprises a plastic moulded holder 72 having a cylindrical portion at one end to accommodate the cylinder lock 46 and a part cylindrical coaxial portion 74 for accommodating a locking element in the form of a rotor 76. A torsion spring 78 mounts over the rearwardly extending barrel 50, the barrel having a square shaped ariel aperture for accommodating a square actuation bar of a rear unit described below. Upon assembly, the torsion spring is mounted to bias the rotor anti clockwise as seen in FIG. 1 and FIG. 3 towards its locking position. The rotor has a front barrel 80 with a rectangular axial slot accommodating a conventional flat operating bar 79 extending from the cylinder lock 46. The cylinder lock conventionally has a degree of lost motion so that initial turning by a key does not turn the bar 79 or the rotor but further action in a clockwise sense (as seen in FIG. 1 and FIG. 3) then turns the rotor to disengage a tongue retaining finger 82 of the rotor to release the tongue 28 to move upwardly under the biasing of spring 32 thereby releasing a striker arm so that the associated gate may be opened. The torsion spring 78 then acts to urge the rotor anti clockwise (as seen in FIG. 1 and FIG. 3) until the side face of finger 82 inter engages with a side face of the tongue 28 thereby holding the latch mechanism to be armed with the striker pin when the gate is closed.

For this purpose, the tongue 28 has a protruding leg 84 (see FIG. 1) which interferes with the side of the finger 82 when the tongue is in the closed position. The profile of the tongue includes an abutment shoulder 86 configured such that when impacted by the striker arm 70, the tongue is rotated anticlockwise as seen in FIG. 1 to move the leg 84 rearwardly of the location of the finger 82, thereby releasing the rotor to turn under the force of the torsion spring 78 in an anticlockwise direction so that locking is automatically achieved.

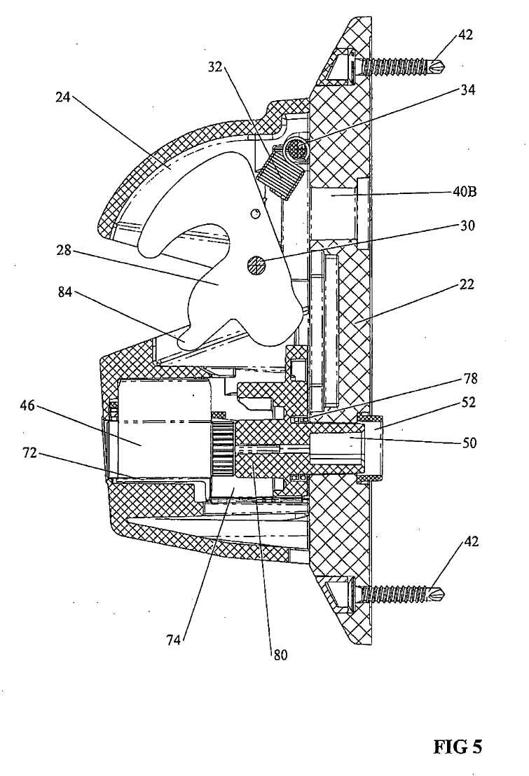

More detail of assembly is shown in FIG. 5 in which, for ease of reading the drawings, the extension spring 32 is shown not engaged with the tongue so it has fallen under gravity the position it will have adopted when pushed in an anticlockwise direction by a striker bar. FIG. 5 is a section in a central plane and shows the space around the leg 84 of the tongue, the side face of the tongue acting as an interference element for a side face of the finger 82 of the rotor (which is visible in FIG. 5).

Referring now to FIG. 4, the optional rear access unit has a housing 90 of general L shape and having a side leg 92 adapted to be fixed by screws 93 to the side of a gate and a casing 94 adapted to mount a lock 96 and an actuator assembly 98. The lock is mounted in a cap 100 which extends axially within a corresponding passage in the casing 94. The housing 90 also mounts a base element 102 to retain lock 96 in button 100. The actuating unit has a body portion 103 so that lock and button are biased to an outward position. The left hand end of the actuator comprises a barrel 105 having a rectangular slot into which the end of the operating bar 106 of the cylinder lock 96 engages for transmitting rotational force. The right hand end of the actuator 104 comprises a substantially square cross section drive bar for engaging in the barrel 50 of the rotor 76. Thus, by virtue of the lock 96 being a left hand operating lock, a key is rotated anti clockwise to take up initial lost motion and then further displaced to rotate the bar 104 clockwise when seen in the view of FIG. 4, whereby the rotor is rotated towards its opening position and can release the latching tongue to more upwardly under the spring bias.

In this embodiment the cap 100 is either not axially displaceable or, if axially displaceable, it is so by virtue of the bar 104 not fully penetrating the cavity in the rotor. In either event, any movement of the button if possible does not cause any function whatsoever but the structure described above has useful design criteria so that the unit may be useable in a second embodiment or, at least, many components of FIG. 4 are useable so that the manufacturer can cost effectively assemble and provide different embodiments for different market needs.

In summary, the embodiment described above lends itself to efficient robust construction with relative simplicity in terms of the number of components and assembly. Furthermore, an important aspect is ease of fitting with hand tools and handheld drills to gates and gate posts. A single aperture is all that is needed to extend between the rear wall and front wall of a gate post in order to mount the optional rear access unit to engage with an align with the front latch assembly. By contrast, if drillings are required at spaced parallel locations there is a great difficulty in achieving on site precision with hand tools.

We claim:

1. A latch for holding closed a gate (or door) wherein the latch is adapted to co operate with a striker arm, the latch comprising:
(a) a housing in which
(b) a displaceable latching element is mounted to be displaceable from a latching position towards an open position in which the striker arm is released for gate opening, and
(c) the latching element having a latching shoulder to retain the striker arm when engaged behind the latching shoulder and having an engagement surface adapted to be engaged by the striker arm when the gate is moved towards a closed position to displace the latching element and for permitting relative movement of the striker arm to adopt a position behind the latching shoulder,
(d) a locking element for locking the latching element and adapted to be displaced between a locking position, in which the latching element is restrained from moving, and a displaced position in which the latching element is free to be moved,
(e) the locking element being biased towards the locking position,
(f) the latching element being biased towards an open position,
(g) the latching element having an interference portion which operates when the latching element has been displaced away from the latching position to prevent the locking element returning to its locking position, and
(h) the arrangement being such that when a striker arm engages the latching element upon closure of an associated gate, the latching element is displaced thereby releasing the interference portion from the locking element whereby the locking element is released to move into the locking position so that a self locking arrangement is provided.

2. A latch as defined in claim 1, where the latch mounts a lock having key actuation to displace the locking element in a rotary sense.

3. A latch as defined in claim 2, wherein the lock is a cylinder lock and the locking element is in the form of a rotor which is rotatable and mounted coaxially with the axis of the cylinder lock.

4. A latch as defined in claim 3, wherein the rotor is rotatable through about 20° between its locking position and its displaced position.

5. A latch as defined in claim 4, wherein the rotor has first and second radially extending projections, the rearward of the projections having a side free for engaging the interference portion of the latching element, the side face being in a radial plane displaced around the axis of the rotor compared with a central radial plane around which the forward of the projections extends. An aperture being defined between the projections for accommodating a projecting tab of the latching element, whereby in the closed position of the latching element is retained by the projecting tab in the aperture.

6. A latch as defined in claim 1, wherein the latching element is in the form of a generally planar element substantially wholly enclosed in the housing for pivotal movement about a horizontal axis within the housing, a spring being provided for biasing the planar element towards the open position.

7. A latch as defined in claim 1, wherein the latch is adapted for co operation with an optional rear actuator unit to be mounted on the opposite side of a gate post to that of the latch, and the locking element is structured so that it can move relative to a base portion of the housing and the base portion of the housing is adapted to receive therethrough an actuating element associated with the rear actuator unit for operating the mechanism and moving the locking element from the locking position and a displaced position.

8. Apparatus comprising a latch as defined in claim 1, in combination with a remote actuator for mounting on the opposite side of a gate to the latch and for actuating the locking element.

9. Apparatus as defined in claim 8, wherein the remote actuator has a cylinder lock arranged to drive a coupling bar which is in engagement with the locking element to rotate it from the locking position to the displaced position.

10. Apparatus as defined in claim 8, wherein the remote actuator has a manual operating actuator which in use moves in a guide towards the associated gate post, its motion being translated to provide drive to move the locking element so that latching is achieved and the gate may be opened, despite a lock provided in the latch housing being in a position to lock the latching element.

11. Apparatus as defined in claim 8, wherein the latch has no key-actuated lock but has a manual opening actuator movable in use towards the associated gate post to provide drive to move the locking element so that unlatching is achieved and the gate may be opened despite the remote actuator having a lock which may be locked.
